(19) United States
(12) Patent Application Publication
(10) Pub. No.: US 2005/0171936 A1
(43) Pub. Date: Aug. 4, 2005

(54) Wireless search engine and method thereof

(76) Inventor: Bo Zhu, Diamond Bar, CA (US)

Correspondence Address: RAYMOND Y. CHAN, 108 N. YNEZ AVE., SUITE 128, MONTEREY PARK, CA, 91754, US

(21) Appl. No.: 10/769,417

(22) Filed: Jan. 30, 2004

(51) Int. Cl. G06F 17/30

(52) U.S. Cl. 707/3

(57) ABSTRACT

A wireless searching method through Wireless Application Protocol (WAP) which includes the steps of: submitting a query by a user of a mobile terminal to a search engine through a wireless telecommunication network; matching at least a query history stored in a user preference file with the query; and selecting the query history to retrieve information of the query history at the mobile terminal. Therefore, the user is able to quickly and precisely to obtain a search result through the mobile terminal by accessing the user preference file in the search engine.

### BACKGROUND OF THE PRESENT INVENTION

1. Field of Invention

The present invention relates to search method, and more particularly to a wireless search engine and method thereof in which searching of information through Internet may be accomplished by wireless telecommunication network through a cellular phone.

2. Description of Related Arts

Various search engines have been widely utilized all over the world. It can not only provide a convenient method for people who seek to obtain information from internet, but can also provide business with an excellent opportunity for advertising their products or services.

A conventional search engine usually comprises an interactive search platform, such as an interactive search webpage for a user to enter instructions for information to be acquired, wherein the interactive search platform is connected to a central server through Internet, such as World Wide Web (www), where the search request is processed. Information, which is usually in the form of a list of matching websites, will then be identified and standardized and then sent back to the interactive search platform, showing the search results to the user.

At time goes by, there is a boost in demand of telecommunication networks. As a result, there is also a boost in demand for wireless internet assess. A system whereby people may access internet through wireless telecommunication network, which is known as Wireless Application Protocol (WAP), has been developed to meet such a demand. Obviously, the development of WAP makes internet access more flexible. By the virtue of WAP, people may search information anywhere they are provided the place where they are in has telecommunication network coverage. However, by the use of cellular phone, WAP introduces disadvantages as compared with conventional internet access and its application, especially for using search engines.

As a matter of fact, those who are using WAP for internet access and search engine applications typically get the information from the mini screen of their respective cellular phone. As a result, the cellular phone screen is often so small that it causes a lot of inconvenience to the user. For example, when one is searching extensive and popular subject matters, he or she may get a huge amount of results which take a very long period of time to transfer back and forth between the cellular phone and the respective WAP server. Moreover, when a lot of information has to be displayed, the mini screens may be incapable of sufficiently meeting the users' need.

Given the inherent difficulty of conventional WAP application as a result of the limited size of cellular phone's screen, a more efficient way of handling and processing information in relation to WAP should be developed.

### SUMMARY OF THE PRESENT INVENTION

A main object of the present invention is to provide a wireless search engine which is to be assessed through Wireless Application Protocol (WAP) for mobile terminals, such as cellular phones, wherein the wireless search engine is capable of analyzing previous search requests of a user to generate a user preference file for effectively providing optimal information to the user upon his subsequent searches. Therefore, the user is able to quickly and precisely to obtain a search result through the mobile terminal by accessing the user preference file in the search engine.

Another object of the present invention is to provide a wireless search engine which is to be assessed through Wireless Application Protocol (WAP) for mobile terminals, such as cellular phones, wherein the wireless search engine is capable of sharing information with the telecommunication network to which the user of the present invention subscribe and by which the user utilizes for WAP application, so as to enrich the user preference file in order to effectively provide optimal information to the user upon his/her subsequent searches.

Another object of the present invention is to provide a wireless search engine which is to be assessed through Wireless Application Protocol (WAP) for mobile terminals, such as cellular phones, wherein the wireless search engine is capable of storing query history for the user, so that for repeated search of the same information, the query history, such as a searched website address, is readily available without restarting a new search again. In other words, the present invention effectively eliminates unnecessary repetition of work done by the search engine, thus providing a more efficient method of searching information.

Another object of the present invention is to provide a wireless search engine which is to be assessed through Wireless Application Protocol (WAP) for mobile terminals, such as cellular phones, wherein data storage and optimal analysis are performed in a search engine, so that hardware requirement on the part of the mobile terminals can be kept minimal while optimal information can be obtained effectively and efficiently.

Another object of the present invention is to provide a wireless searching method though Wireless Application Protocol (WAP) for mobile terminals, such as cellular phones, wherein a user's query history and particulars are collected and analyzed to generate a user preference file, which is then utilized for providing optimal information for that user in subsequent searches.

Accordingly, in order to accomplish the above objects, the present invention provides a wireless searching method through Wireless Application Protocol (WAP), comprising the steps of:
(a) submitting a query by a user of a mobile terminal to a search engine through a wireless telecommunication network;
(b) matching at least a query history stored in a user preference file with the query; and
(c) selecting the query history to retrieve information of the query history at the mobile terminal.

The step (b) further comprises a sub-step of:

(b.1) storing the query to be the query history in the user preference file when the query does not match the query history in the user preference file.

Moreover, the present invention also provides a wireless searching system, comprising:
a wireless telecommunication network adapted for wirelessly communicating with at least a mobile terminal; and
a search engine, which is linking with the wireless telecommunication network, adapted for receiving a query by a user at the mobile terminal, wherein the search engine contains at least a user preference file having at least a query history stored therein, wherein the search engine is activated to retrieve the user preference file for matching the query history with the query to retrieve information of the query history at the mobile terminal.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of a wireless searching system according to a preferred embodiment of the present invention.

FIG. 2 is a schematic diagram of a user preference file of the wireless searching system according to the above preferred embodiment of the present invention.

FIG. 3 is a flow diagram of a user preference file of the wireless searching method according to the above preferred embodiment of the present invention, illustrating a search being conducted on the basis of key words.

FIG. 4 is a flow diagram of a user preference file of the wireless searching method according to the above preferred embodiment of the present invention, illustrating the user being able to request recording website's information which the user is accessing as a query history thereof.

FIG. 5 is a flow diagram of a user preference file of the wireless searching method according to the above preferred embodiment of the present invention, illustrating the user being able to retrieve a query history list based on the user preference file.

FIG. 6 is a flow diagram of a user preference file of the wireless searching method according to the above preferred embodiment of the present invention, illustrating an analyzing process being utilized to cure query uncertainty and vagueness.

FIG. 7 is a flow diagram of a user preference file of the wireless searching method according to the above preferred embodiment of the present invention, illustrating the query result being sent to the user through email.

FIG. 8 is a flow diagram of a user preference file of the wireless searching method according to the above preferred embodiment of the present invention, illustrating query result being sent to the user through Short Message Service (SMS).

FIG. 9 is a schematic diagram illustrating the structure of the wireless searching system according to the above preferred embodiment of the present invention.

### DETAILED DESCRIPTION OF THE PREFERRED EMBODIMENT

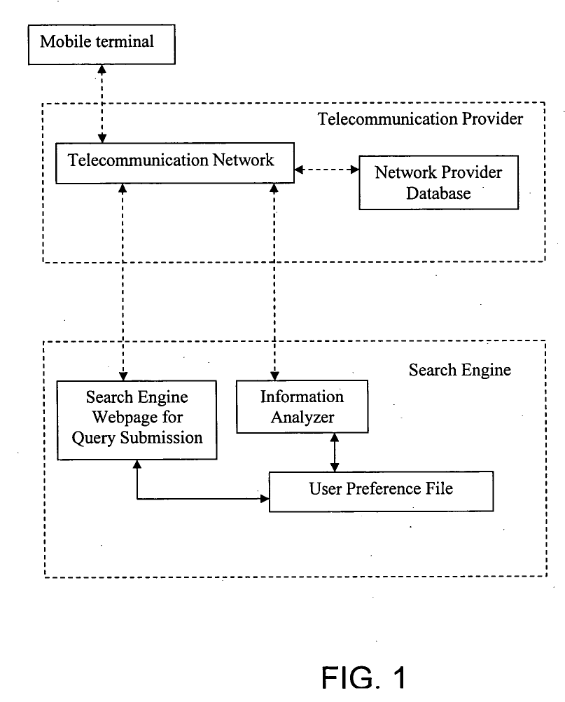

Referring to FIG. 1 of the drawings, a wireless searching method for use through Wireless Application Protocol (WAP) according to a preferred embodiment of the present invention is illustrated. The wireless searching method comprises the following steps.

(1) Submit a query by a user of a mobile terminal to a search engine through a wireless telecommunication network.

(2) Match at least a query history stored in a user preference file with the query.

(3) Select the query history to retrieve information of the query history to the mobile terminal.

According to the preferred embodiment, the wireless searching method is preformed through a wireless searching system comprising a wireless telecommunication network adapted for wirelessly communicating with at least one mobile terminal and a search engine.

The search engine is linked with the wireless telecommunication network, and adapted for receiving the query by the user from the mobile terminal, wherein the search engine contains at least a user preference file having at least a query history stored therein, in which the search engine is activated to retrieve the user preference file for matching the query history with the query to retrieve information of the query history at the mobile terminal.

In step (1) above, the mobile terminal is preferably embodied as a PDA or a regular cellular phone having a display provided thereon in which the user is able to observe the display for acquiring information and monitoring the operation of the cellular phone or the PDA.

The mobile terminal, such as the cellular phone, is communicatively covered by a telecommunication network provided by a predetermined telecommunication network provider, such as ‘Cingular’ or ‘AT&T’ in Southern California, and subscribed by the user of the present invention. In order to access the user preference file in the search engine, before the step (1), the search engine must recognize the corresponding user through the telecommunication network. Accordingly, the user preference file is accessed by the telephone number, SIM card number, or account number of the user of the mobile terminal. In other words, the user preference file is linked to the telephone number, SIM card number, or account number of the user of the mobile terminal once the mobile terminal is switched on.

The query is preferably embodied as a form of a search request which is to be inputted through a control panel provided at the mobile terminal. The mobile terminal then transmits the query to the search engine via the telecommunication network.

The step (2) above further comprises a sub-step (2.1) of storing the query to be the query history in the user preference file when the query does not match the query history in the user preference file.

The user preference file is developed in the search engine for storing query history and the personal particulars of the user of the present invention. In particular, the search engine is arranged to link to the telecommunication network provider such that the respective subscription information to the telecommunication network by the user is capable of sharing with the search engine to constitute the user preference file.

According to the preferred embodiment, the subscription information may include the user's address, postal code, name, age group, occupation . . . etc so that such information is shared to the user preference file and when subsequent quires related to these information are made, such as query to weather and traffic conditions, the corresponding information with respect to the geographic area in which the user is living can be sent to the user without needing any clarification as to, say, which geographic area the user is looking for. Of course, when the user indeed wants to make a query as to the information of a place which is not recorded in the user preference file, the user always can make such a fresh query regardless of the user preference file.

In other words, the user preference file is not utilized to dictate or limit what information a user may search, instead, it helps in providing the optimal information to the user in light the user's unique information and query history.

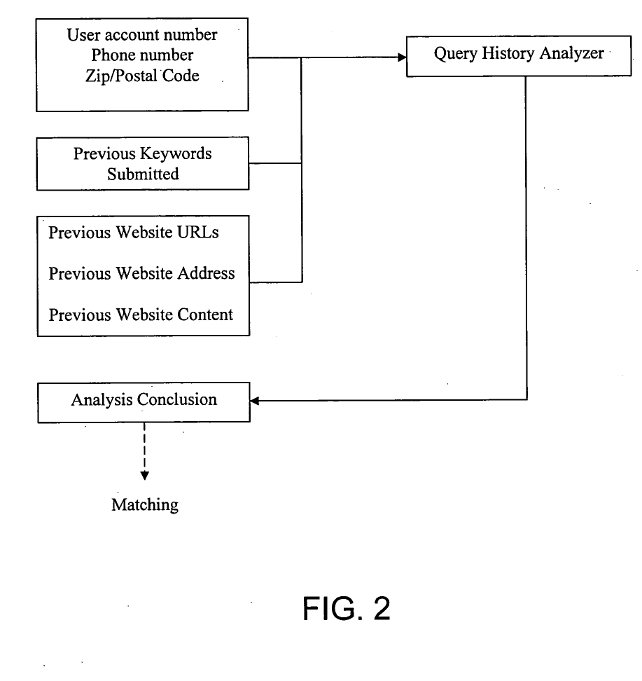

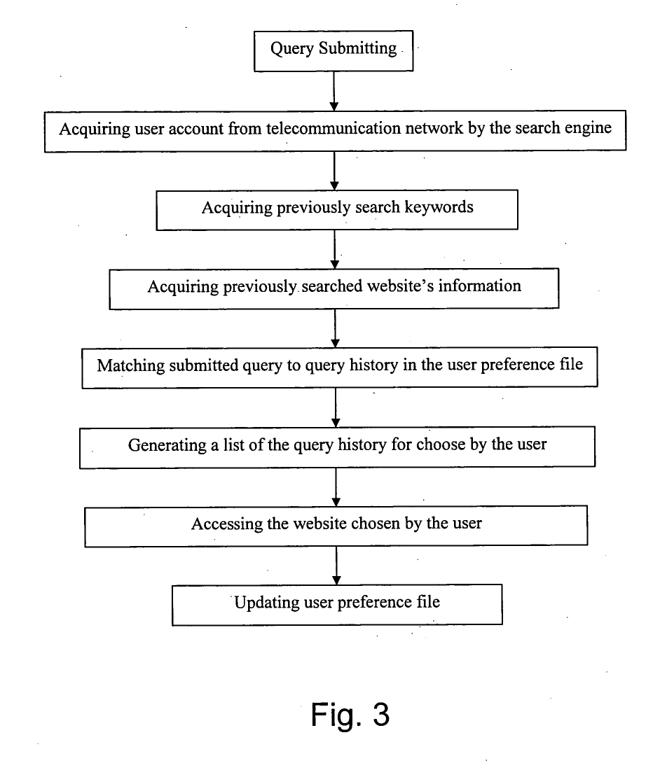

Moreover, as shown in FIGS. 2 and 3 of the drawings, the information stored in the user preference file may also contain information about the previously searched or accessed websites' addresses. For instances, the previously websites' addresses are stored in the user preference file in such a manner that during subsequent queries, an alphabet may invoke a list of website's addresses generated by the user preference file wherein the website addresses in the list are all starting from that alphabet. In other words, the user, who wants to make a query about a website having an address starting with that alphabet, no longer needs to retype the full address. Instead, the user may choose the intended website from the list generated by the user preference file.

The wireless searching system further comprises a telecommunication center provided at the telecommunication network which is linked to the search engine, wherein the subscription information of the user submitted to the telecommunication network is shared with the search engine for constituting the user preference file.

Furthermore, in step (2) above, the matching process may be performed on the basis of keywords matching, instead of the actual website addresses. For example, the user may in a pervious query make a search of ‘newspapers’ as the keyword, and chose to access a particular newspaper website, then, in subsequent quires about newspapers, that particular newspaper's website is readily available for selection.

The step (3) above further comprises the following steps.

(3.1) Display a list of query history stored in the user preference file at the mobile terminal with respect to the query submitted by the user.

(3.2) Select the particular query history to be accessed by the user making the query.

(3.3) Access the information corresponding to the query history selected by the user.

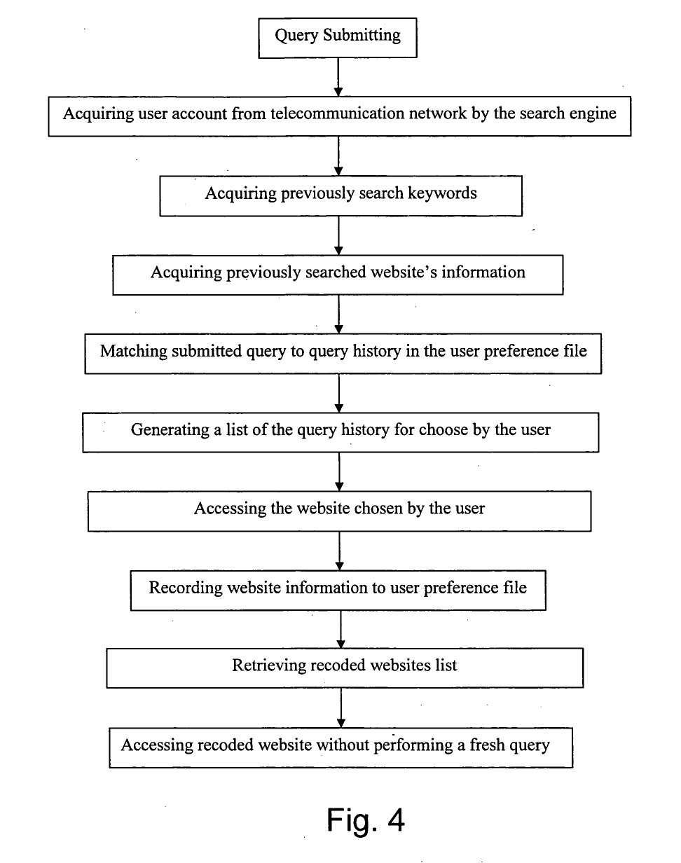

Referring to FIG. 4 of the drawings, the wireless searching method further comprises a step (4) of recording website information as a query history in the search engine as requested by the user. Thus, in the future, when the user wants to go back to the website, he/she may just retrieve recorded query history without performing any fresh query again.

According to the preferred embodiment of the present invention, in step (3.2), the list of query history may take the form of a list of keywords which are utilized for querying the particular information, or alternatively, it can be a list of website addresses, URLs, and other websites identification parameters.

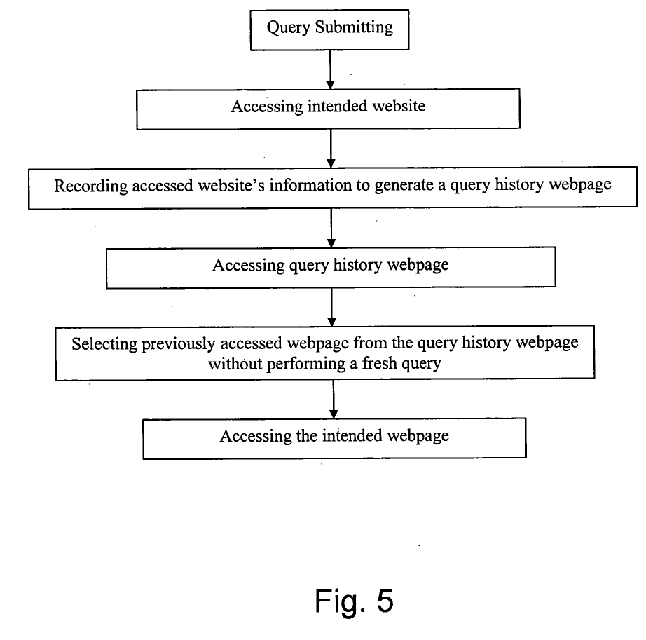

Moreover, as shown in FIG. 5 of the drawings, the list of possible query history may be presented in the form of a query history webpage which can readily be accessible by the user of the search engine through the telecommunication network and his/her cellular phone.

In relation to the query history webpage, before the step (3), the wireless searching method further comprises a step of updating information with respect to the websites recorded in the query history.

Very often, websites parameters, such as a website address, are changed due to administrative constraint. In such cases, the website information with respect to the changed website will be outdated, leaving the user being unable to re-locate or re-access the previously accessed but subsequently changed website. The updating step therefore caters for this discrepancy.

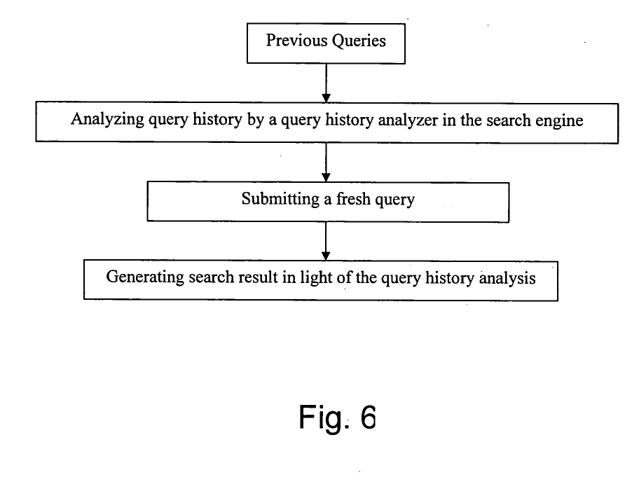

In addition, referring to FIG. 6 of the drawings, the wireless searching method further comprises a step (5) of analyzing the query history of the user to match the query history in the user preference file which is nearest possible to the query when the query is uncertain and vague. Accordingly, the wireless searching system further comprises a query history analyzer installed into the search engine and arranged in such a manner that when the query is uncertain and vague, the matching process is adapted to locate the nearest possible information in the user preference file.

For example, when a particular query cannot match exactly with the information stored in the user preference file, and information available in the Internet, the wireless searching method will, based on the query history on the user, match with the nearest possible query history in the user preference file.

Accordingly, the step (5) may be processed between the step (2) and the step (3) so that any vagueness and uncertainty in the query history could be addressed in such a manner that the nearest possible information are found for the user's reference. According to the preferred embodiment, the analyzing process may be carried out by typical statistical approaches, such as the frequency of making a particular query history, taking into account the age group, gender, or the education background of the user.

It is worth mentioning that the wireless searching method disclosed above is adapted to be utilized for a wide variety of operation systems, so that the compatibility with respect to different operation systems can be maximized.

According to the preferred embodiment, the website information which is to be recoded as the query history may include the website address, Uniform Resource Location (URL) of that particular website, or even a hyperlink of another website.

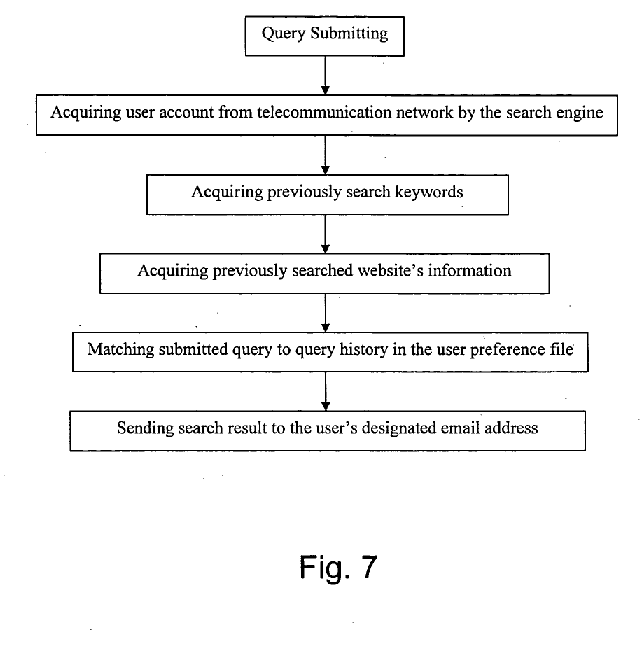

Referring to FIG. 7 of the drawings, the step (3) further comprises a step (3.4) of sending out the information of a search result with respect to the query to the user through email so that more extensive information could be given to the user without immediately occupying the mobile terminal's capacity storage of information.

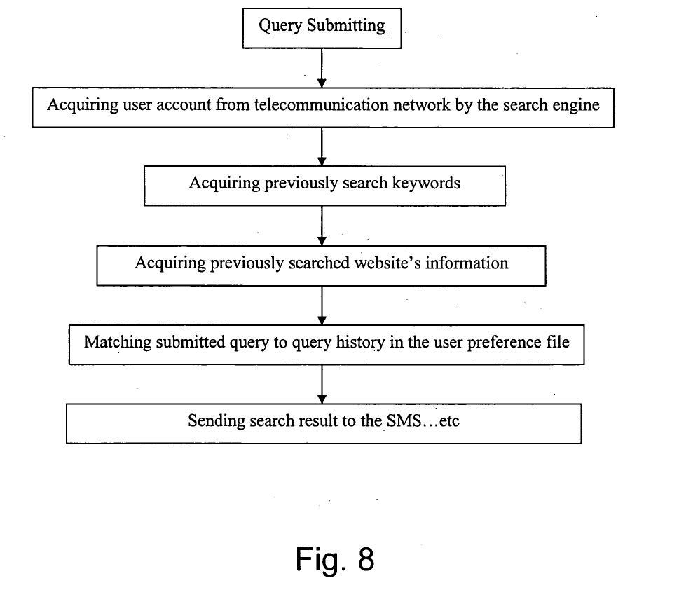

Alternative, as shown in FIG. 8 of the drawings, step (3.4) can be altered as a step (3.4′) of sending out the information of a search result with respect to the query to the user through Short Message Service (SMS) so that for each particular query, the user doesn't need to wait until he/she gets the result. Therefore, the user can be able to perform another query while searching is still being performed. The result for the first search is sent to the user through SMS when it is available. Thus, the time required for continuous queries can be minimized.

In other words, after a particular query history is found in the user preference file, the result can be sent directly to the mobile terminal. Or alternatively, the result could be sent to the user through email or SMS, so that greater amount of information may be sent through the wireless searching system without occupying too much memory space of the mobile terminal.

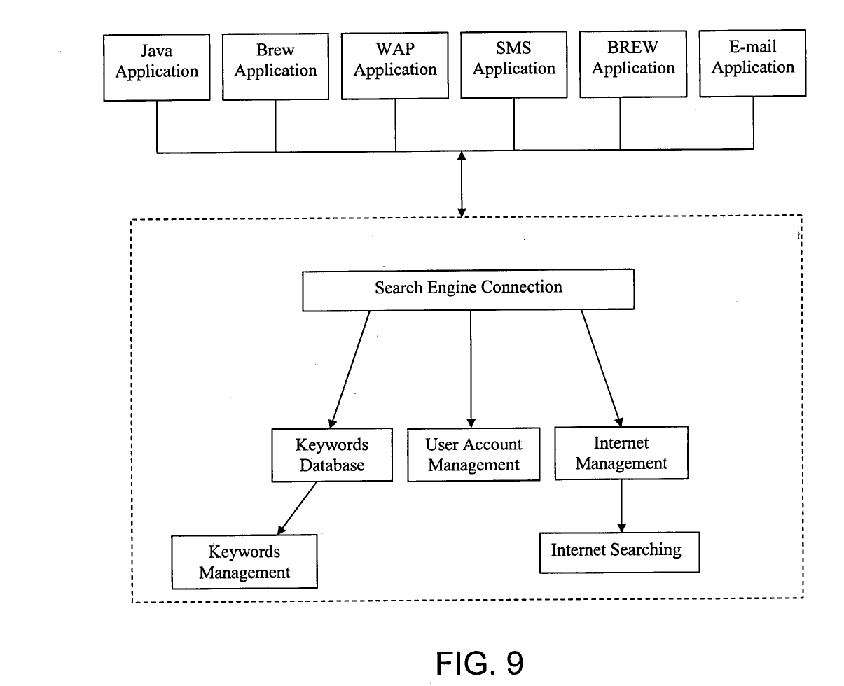

It is worth to mention that the searching system of the search engine is organized to output the search result in a particular format that is adapted for all kinds of applications, such as Java application, BREW application, WAP application, SMS application, or email application, to be retrieved, as shown in FIG. 9.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A wireless searching method through Wireless Application Protocol (WAP), comprising the steps of:
(a) submitting a query by a user of a mobile terminal to a search engine through a wireless telecommunication network;
(b) matching at least a query history stored in a user preference file with the query; and
(c) selecting the query history to retrieve information of the query history at the mobile terminal.

2. The wireless searching method, as recited in claim 1, wherein said step (b) further comprises a sub-step (b.1) of storing said query to be said query history when said query does not match said query history in said user preference file.

3. The wireless searching method, as recited in claim 1, wherein said step (c) further comprises the steps of:
(c.1) displaying a list of query history stored in said user preference file at said mobile terminal with respect to said query submitted by said user;
(c.2) selecting the particular query history to be accessed by said user making said query; and
(c.3) accessing said information corresponding to said query history selected by said user.

4. The wireless searching method as recited in claim 2, wherein the step (c) further comprises a step of updating information with respect to a website recorded in said query history in such a manner that said user is capable of retrieving said website information again through said query history.

5. The wireless searching method, as recited in claim 1, further comprising a step of analyzing said query to match with said query history in said user preference file which is nearest possible to said query when said query is uncertain and vague.

6. The wireless searching method, as recited in claim 4, further comprising a step of analyzing said query to match with said query history in said user preference file which is nearest possible to said query when said query is uncertain and vague.

7. The wireless searching method as recited in claim 1, before the step (1), further comprising a step recognizing said user to access said user preference file by a phone number of said mobile terminal.

8. The wireless searching method as recited in claim 6, before the step (1), further comprising a step recognizing said user to access said user preference file by a phone number of said mobile terminal.

9. The wireless searching method, as recited in claim 1, wherein said step (c) further comprises a step of sending out said information of a result with respect to said query to said user through email thereof.

10. The wireless searching method, as recited in claim 4, wherein said step (c) further comprises a step of sending out said information of a result with respect to said query to said user through email thereof.

11. The wireless searching method, as recited in claim 8, wherein said step (c) further comprises a step of sending out said information of a result with respect to said query to said user through email thereof.

12. The wireless searching method, as recited in claim 1, wherein said step (c) further comprises a step of sending out said information of a result with respect to said query to said user through Short Message Service (SMS).

13. The wireless searching method, as recited in claim 4, wherein said step (c) further comprises a step of sending out said information of a result with respect to said query to said user through Short Message Service (SMS).

14. The wireless searching method, as recited in claim 8, wherein said step (c) further comprises a step of sending out said information of a result with respect to said query to said user through Short Message Service (SMS).

15. The wireless searching method, as recited in claim 1, wherein said search engine is arranged to link with a telecommunication network provider of said telecommunication network wherein subscription information to said telecommunication network of said user is shared with said search engine to constitute said user preference file.

16. The wireless searching method, as recited in claim 1, wherein said search engine is arranged to link with a telecommunication network provider of said telecommunication network, wherein subscription information of said user submitted to said telecommunication network is shared with said search engine to constitute said user preference file.

17. The wireless searching method, as recited in claim 4, wherein said search engine is arranged to link with a telecommunication network provider of said telecommunication network, wherein subscription information of said user submitted to said telecommunication network is shared with said search engine to constitute said user preference file.

18. The wireless searching method, as recited in claim 8, wherein said search engine is arranged to link with a telecommunication network provider of said telecommunication network, wherein subscription information of said user submitted to said telecommunication network is shared with said search engine to constitute said user preference file.

19. A wireless searching system, comprising:
a wireless telecommunication network adapted for wirelessly communicating with at least a mobile terminal; and
a search engine, which is linking with said wireless telecommunication network and Internet, adapted for receiving a query by a user at the mobile terminal, wherein said search engine contains at least a user preference file having at least a query history stored therein, wherein said search engine is activated to retrieve said user preference file for matching said query history with said query to retrieve information of said query history at said mobile terminal.

20. The wireless searching system, as recited in claim 19, further comprising a telecommunication center which provides said telecommunication network which is linked to said search engine, wherein subscription information of said telecommunication network is shared with said search engine for constituting said user preference file.

21. The wireless searching system, as recited in claim 20, further comprising a query history analyzer installed into said search engine, wherein said query history analyzer is adapted to analyze said query to match a query history in said user preference file which is nearest possible to said query history of said user when said query is vague and uncertain.

22. The wireless searching system, as recited in claim 19, wherein said user preference file of said search engine is accessed through said wireless telecommunication network with respect to a corresponding phone number of said mobile terminal of said user.

23. The wireless searching system, as recited in claim 21, wherein said user preference file of said search engine is accessed through said wireless telecommunication network with respect to a corresponding phone number of said mobile terminal of said user.
